(19) United States
(12) Patent Application Publication
(10) Pub. No.: US 2017/0248863 A1
(43) Pub. Date: Aug. 31, 2017

(54) IMAGE FORMING APPARATUS

(71) Applicant: Oki Data Corporation, Tokyo (JP)

(72) Inventor: Yuichi FURUKAWA, Tokyo (JP)

(21) Appl. No.: 15/436,177

(22) Filed: Feb. 17, 2017

(30) Foreign Application Priority Data
Feb. 29, 2016 (JP) 2016-036717

(51) Int. Cl. G03G 9/00

(52) U.S. Cl. CPC G03G 15/0126

(57) ABSTRACT

An image forming apparatus for developing an electrostatic latent image with developer includes a development part, a transfer part, and a fuser. The developer includes first developer with a first coloring agent of yellow and a first external additive, and second developer with a second coloring agent of a color other than yellow and a second external additive. A first peeling rate of the first external additive by a following formula (1) is smaller than a second peeling rate of the second external additive by a following formula (2),

the first peeling rate (%)=[1−(X1/Y1)]×100 (1)

the second peeling rate (%)=[1−(X2/Y2)]×100 (2)
X1, Y1 are amounts (weight %) of the first external additive in the first developer after/before the ultrasonic waves are applied,
X2, Y2 are amounts (weight %) of the second external additive in the second developer after/before the ultrasonic waves are applied.

### CROSS REFERENCE

This application is related to, claims priorities from, and incorporate by reference Japanese Patent Application No. 2016-036717 filed on Feb. 29, 2016. This application is related to and incorporates by reference a co-pending US patent application entitled IMAGE FORMING APPARATUS, filed on the same day as this application, claiming the priority from Japanese Patent Application No. 2016-036716

### TECHNICAL FIELD

The present invention relates to an image forming apparatus for forming an image using a developer including an external additive together with a yellow coloring agent and one, two or more developers including an external additive together with a coloring agent other than a yellow coloring agent.

### BACKGROUND

An electrographic image forming apparatus is widely used. Compared to an image forming apparatus of other systems, such as an inkjet system, a high quality image can be obtained in a short time.

In an image forming apparatus, an image is formed on a surface of a medium such as paper. In the image forming step, after an electrostatic latent image is adhered to a surface of a photosensitive drum, a developer is adhered to the electrostatic latent image. Since the developer adhered to the electrostatic latent image is transferred to the surface of the medium and then heated and pressured, it is fused to the medium.

A developer includes an external additive as well as a coloring agent. The external additive functions to suppress agglomeration of developers.

In an image forming apparatus for forming a color image, a developer including a yellow coloring agent, and one, two or more developers including a coloring agent of a color other than yellow are used together.

Since a configuration of a developer affects quality of an image, various considerations have been made with respect to the configuration of the developer. Specifically, to suppress the occurrence of a phenomenon (filming) in which a foreign object adheres to the surface of a photosensitive body, the configuration of the external additive is optimized (For example, see Patent Document 1).

### RELATED ART

[Patent Doc. 1] JP Patent 5737556

Although specific considerations are made relating to a configuration of a developer, since quality of an image formed using a developer is not satisfactory yet, there is room for improvement.

The present invention was made in view of the aforementioned problems, and aims to provide an image forming apparatus capable of obtaining a high quality image.

### SUMMARY

An image forming apparatus for developing an electrostatic latent image with developer, which is disclosed in the application, includes a development part that attaches the developer to the electrostatic latent image; a transfer part that transfers the developer attached to the electrostatic latent image to a medium; and a fuser that fuses the developer on the medium. Wherein the developer includes first developer including a first coloring agent of yellow and a first external additive, and second developer including a second coloring agent of a color other than yellow and a second external additive; a first peeling rate of the first external additive calculated by a following formula (1) is smaller than a second peeling rate of the second external additive calculated by a following formula (2),

the first peeling rate (%)=[1−(X1/Y1)]×100 (1)

the first peeling rate is determined when ultrasonic waves are applied to a polyoxyethylene lauryl ether solution in which the first developer is dispersed, X1 is an amount (weight %) of the first external additive included in the first developer after the ultrasonic waves are applied, Y1 is an amount (weight %) of the first external additive included in the first developer before the ultrasonic waves are applied, the polyoxyethylene lauryl ether solution is set such that a density=5% and a temperature=32° C., and the application of the ultrasonic waves is set such that strength=40 kHz and time=10 minutes,

the second peeling rate (%)=[1−(X2/Y2)]×100 (2)

the second peeling rate is determined when ultrasonic waves are applied to the polyoxyethylene lauryl either solution in which the second developer is dispersed, X2 is an amount (weight %) of the second external additive included in the second developer after the ultrasonic waves are applied, Y2 is an amount (weight %) of the second external additive included in the second developer before the ultrasonic waves are applied, the polyoxyethylene lauryl ether solution is set such that a density=5% and a temperature=32° C., and the application of the ultrasonic waves is set such that strength=40 kHz and time=10 minutes.

The aforementioned “polyoxyethylene lauryl ether solution” is a solution including polyoxyethylene lauryl ether (PLE), which is an ether-type nonionic surfactant, and specifically, EMULGEN 109P (product name) manufactured by Kao Corporation. To disperse the first developer or the second developer in the PLE solution, 5 parts by weight of the first developer or the second developer is added to 100 parts by weight of a PLE solution, and the PLE solution in which the first developer or the second developer is added is stirred for three hours or more. However, the value of the first peeling rate calculated using the formula (1) is a value rounded off the second decimal place. Similarly, the value of the second peeling rate calculated using the formula (2) is a value rounded off the second decimal place.

According to an image forming apparatus relating to an embodiment of the present invention, the first peeling rate of the first external additive on to the first developer including a yellow first coloring agent is less than the second peeling rate of the second external additive ono the second developer including a second coloring agent of a color other than yellow. Therefore, a high quality image can be obtained.

### BRIEF DESCRIPTION OF THE DRAWINGS

FIG. 1 is a view showing a planar configuration of an image forming apparatus according to one embodiment of the present invention.

FIG. 2 is an enlarged plan view of the configuration of the developing unit shown in FIG. 1.

FIG. 3 is a view schematically showing the configuration of the developer.

### DETAILED DESCRIPTION OF PREFERRED EMBODIMENTS

Hereinafter, an embodiment of the present invention will be described in detail with reference to the drawings. The order of the descriptions is as follows:

### 1. Image Forming Apparatus

1-1. Overall Configuration

1-2. Detail Configuration of Development Part

1-3. Configuration and Manufacturing Method of Developer

1-4. Operations

1-5. Functions and Effects

### 2. Modified Example

### 1. Image Forming Apparatus

The image forming apparatus of one embodiment of the present invention will be described.

The image forming apparatus described herein is, for example, a full-color electrographic printer, and forms an image on a surface of a medium M. The material of the medium M is not especially limited, but, for example, it is any one, two or more types of paper, a film, etc.

<1-1. Overall Structure>

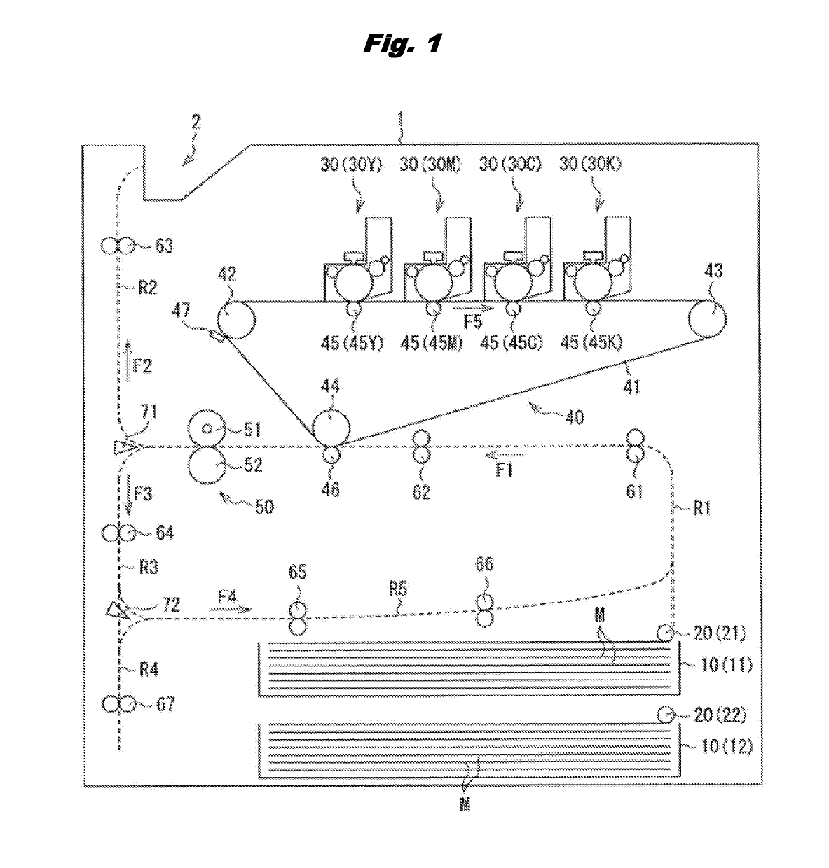

Initially, the overall structure of the image forming apparatus will be described. FIG. 1 shows a configuration of the image forming apparatus in a plan view.

The image forming apparatus, as shown in FIG. 1, includes, for example, one, two or more trays 10, one, two or more send out rollers 20, one, two or more development parts 30, a transfer part 40, a fuser 50, carrying rollers 61 to 67, and carrying path switching guides 71 and 72 inside the housing 1.

Further, in the housing 1, a stacker part 2 is provided for ejecting a medium M in which an image is formed, and the medium M is carried along the carrying paths R1 to R5.

[Tray and Send Out Roller]

The tray 10 accommodates mediums M and is, for example, removably attached to the housing 1. In this tray 10, for example, a plurality of mediums M are accommodated in a stacked manner, and the plurality of mediums M are taken out one by one from the tray 10 by the send out roller 20.

Here, the image forming apparatus is equipped with, for example, two trays 10 (11, 12) and two send out rollers 20 (21, 22). The two trays 11 and 12 are, for example, arranged so as to overlap each other.

[Development Part]

The development part 30 performs a development process using a developer (so-called toner). Specifically, the development part 30 forms an electrostatic latent image, as well as a developer image (so-called toner image) by making a developer adhere to the electrostatic latent image using a Coulomb force.

This developer includes a yellow developer (first developer) including a yellow coloring agent (first coloring agent) and one, two or more developers of another color (second developer) including a coloring agent of another color (second coloring agent). Since the “coloring agent of another color” is a coloring agent of a color other than yellow, the “developer of another color” is a developer of a color other than yellow. The color of the image formed using a developer is mainly determined according to the composition of the coloring agent included in the developer. The composition of the coloring agent is, for example, the color of the coloring agent, the number of the coloring agents, the combination of the colors, etc. Along with this, the type (number and color) of the developer of another color used with the yellow developer is determined according to the image formed using the developer. The detailed configuration of the developer will be described later (see FIG. 3).

Here, the image forming apparatus is equipped with, for example, four development parts 30 (30Y, 30M, 30C, and 30K).

Each of the development parts 30Y, 30M, 30C, and 30K are, for example, removably attached to the housing 1 and arranged along the movement path of a later described intermediate transfer belt 41. Here, the development parts 30Y, 30M, 30C, and 30K are, for example, arranged in the movement direction of the intermediate transfer belt 41 from the upstream side to the downstream side in that order.

The development parts 30Y, 30M, 30C, and 30K have, for example, the same configuration except that the type of the developer accommodated in the later described cartridge 38 is different. Further, the detailed configuration of each of the development parts 30Y, 30M, 30C, and 30K will be described later.

[Transfer Part]

The transfer part 40 performs a transfer process using the developer which was subjected to a development process by the development part 30. Specifically, the transfer part 40 transfers the developer adhered to the electrostatic latent image by the development part 30 to the medium M.

The transfer part 40 includes, for example, an intermediate transfer belt 41, a drive roller 42, a driven roller (idler roller) 43, a backup roller 44, one, two or more primary transfer rollers 45, a secondary transfer roller 46, and a cleaning blade 47.

The intermediate transfer belt 41 is an intermediate transfer medium to which a developer is temporarily transferred before the developer is transferred to the medium M. The intermediate transfer belt 41 is, for example, an endless elastic belt, and includes any one type or two or more types of polymer compounds, such as polyimide. The intermediate transfer belt 41 is movable according to the rotation of the drive roller 42 in a state in which it is stretched by the drive roller 42, the driven roller 43, and the backup roller 44.

The drive roller 42 is rotatable in a clockwise direction via a drive source, such as a motor. The driven roller 43 and the backup roller 44 are each rotatable in the clockwise direction according to the rotation of the drive roller 42, similarly to the drive roller 42.

The primary transfer roller 45 transfers the developer supplied from the development part 30 to the intermediate transfer belt 41 (primary transfer). This primary transfer roller 45 is contacted and pressed to the development part 30 (later described photosensitive drum 31) via the intermediate transfer belt 41. The primary transfer roller 45 is rotatable in the clockwise direction according to the movement of the intermediate transfer belt 41.

Here, the transfer part 40 includes, for example, four primary transfer rollers 45 (45Y, 45M, 45C, and 45K) corresponding to the four development parts 30 (30Y, 30M, 30C, and 30K). Further, the transfer part 40 includes one secondary transfer roller 46 corresponding to one backup roller 44.

The secondary transfer roller 46 transfers (secondarily transfers) the developer transferred onto the intermediate transfer belt 41 to the medium M. This secondary transfer roller 46 is contacted and pressed against the backup roller 44 and includes, for example, a metallic core material and an elastic layer, such as a foamed rubber layer, covering the outer circumferential surface of the core material. The secondary transfer roller 46 is rotatable in the counterclockwise direction according to the movement of the intermediate transfer belt 41.

The cleaning blade 47 is contacted and pressed against the intermediate transfer belt 41 to scrape the unneeded developer remaining on the surface of the intermediate transfer belt 41.

[Fuser]

The fuser 50 performs a fusing process using the developer transferred to the medium M by the transfer part 40. Specifically, the fuser 50 fuses the developer to the medium M by applying heat to the developer transferred to the medium M by the transfer part 40 while applying a pressure.

The fuser 50 includes, for example, a heat application roller 51 and a pressure application roller 52.

The heat application roller 51 is a rotation body for heating the developer image and rotatable in the clockwise direction. The heat application roller 51 includes, for example, a hollow and cylindrical metallic core and a resin coat formed on the surface of the metallic core. The metallic core includes, for example, a metallic material, such as aluminum. The resin coats include, for example, a polymer compound, such as, e.g., a copolymer of tetrafluoroethylene and perfluoroalkyl vinyl ether (PFA) and polytetrafluoroethylene (PTFE).

Inside the heat application roller 51 (metallic core), for example, a heater, such as a halogen lamp, is arranged. The surface temperature of the heat application roller 51 is detected by, for example, a thermistor arranged at a position away from the heat application roller 51.

The pressure application roller 52 is a rotation body for applying pressure to the developer image and rotatable in the counterclockwise direction while being contacted and pressed to the heat application roller 51. The pressure application roller 52 is, for example, a metal rod. The metal rod includes, for example, a metallic material, such as aluminum.

[Carrying Roller]

Each of the carrying rollers 61 to 67 includes a pair of rollers arranged so as to face each other via the carrying paths R1 to R5 of the medium M, and carries the medium M taken out by the send out roller 20. Specifically, for example, when an image is formed only on one side of the medium M, the medium M is carried by the carrying rollers 61 to 63 along the carrying paths R1 and R2. Further, for example, when an image is formed on both sides of the medium M, the medium M is carried by the carrying rollers 61 to 67 along the carrying paths R1 and R5.

[Carrying Path Switching Guide]

The carrying path switching guides 71 and 72 switch the carrying direction of the medium M according to the condition, such as the pattern of the image to be formed on the medium M (whether the image is formed only on one side of the medium M or the image is formed on both sides of the medium M).

<1-2. Detailed Configuration of Development Part>

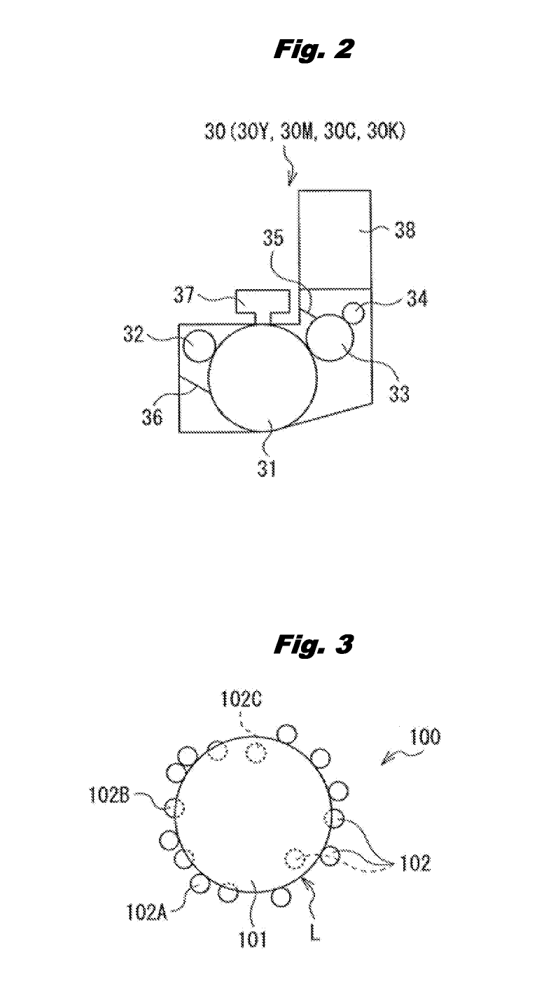

Next, the detailed configuration of the development part 30 shown in FIG. 1 will be described. FIG. 2 shows an enlarged configuration of the development part 30 in plan view.

The development parts 30Y, 30M, 30C, and 30K are, for example, as shown in FIG. 2, each includes a photosensitive drum 31, a charge roller 32, a development roller 33, a supply roller 34, a development blade 35, a cleaning blade 36, a light emitting diode (LED) head 37, and a cartridge 38.

The photosensitive drum 31 is, for example, an organic photosensitive body that includes a cylindrical conductive support and a photoconductive layer that covers the outer circumferential surface of the conductive support, and rotatable in a counterclockwise direction via a drive source, such as a motor. The conductive support is, for example, a metallic pipe including any one type or two or more types of metallic materials, such as aluminum. The photoconductive layer is, for example, a laminated body including a charge generation layer, a charge transportation layer, etc.

The charge roller 32 includes, for example, a metal shaft and a semiconductive epichlorohydrin rubber layer covering the outer circumferential surface of the metal shaft, and is rotatable in the clockwise direction. The charge roller 32 is contacted and pressed to the photosensitive drum 31 to charge the photosensitive drum 31.

The development roller 33 includes, for example, a metal sheet and a semiconductive urethane layer covering the outer circumference surface of the metal sheet, and is rotatable in the clockwise direction. This development roller 33 carries the developer supplied from the supply roller 34 and makes the developer adhere to the electrostatic latent image formed on the surface of the photosensitive drum 31.

The supply roller 34 includes, for example, a metal shaft and a semiconductive foamed silicon sponge layer covering the outer circumferential surface of the metal shaft, and is rotatable in the counterclockwise direction. The supply roller 34 supplies the developer to the surface of the photosensitive drum 31 while sliding on the development roller 33.

The development blade 35 regulates the thickness of the developer supplied to the surface of the supply roller 34. The development blade 35 is arranged, for example, at a position away from the development roller 33 by a predetermined distance, and the thickness of the developer is controlled based on the gap between the development roller 33 and the development blade 35. Further, the development blade 35 includes, for example, any one type or two or more types of metallic materials, such as stainless steel.

The cleaning blade 36 scrapes the unneeded developer remaining on the surface of the photosensitive drum 31. This cleaning blade 36 extends, for example, in a direction approximately parallel to the extending direction of the photosensitive drum 31 and is contacted and pressed to the photosensitive drum 31. Further, the cleaning blade 36 includes, for example, any one type or two or more types of polymer compounds, such as urethane rubber.

The LED head 37 is an exposure device for forming an electrostatic latent image on the surface of the photosensitive drum 31 by exposing the surface of the photosensitive drum 31, and includes, for example, an LED element, a lens array, etc. The LED element and the lens array are arranged so that the light (irradiation light) output from the LED element forms an image on the surface of the photosensitive drum 31.

The cartridge 38 is, for example, removably attached to the development part 30, and contains a developer. The color of the developer contained in the cartridge 38 is, for example, as follows. In the cartridge 38 of the development part 30Y, for example, a yellow developer (first developer) is contained. In the cartridge 38 of the development part 30M, for example, a magenta developer (second developer), which is a developer of another color, is contained. In the cartridge 38 of the development part 30C, for example, a cyan developer (second developer), which is a developer of another color, is contained. In the cartridge 38 of the development part 30K, for example, a black developer (second developer), which is a developer of another color, is contained. That is, here, for example, three types of developers of other colors are used together with the yellow developer. With this, the combination of colors is a combination of, for example, four colors: yellow, magenta, cyan, and black.

<1-3. Configuration and Manufacturing Method of Developer>

Next, the configuration and the manufacturing method of the developer will be described. FIG. 3 schematically shows the cross-sectional configuration of the yellow developer 100, which is a developer used in the aforementioned image forming apparatus.

The yellow developer 100 described herein is, for example, a developer of a single component development system, and more specifically a negatively chargeable developer.

A single component development system denotes a system for applying an appropriate charge amount to the developer itself without using a carrier (magnetic particles) for applying an electric charge to the developer. On the other hand, a two component development system denotes a system for applying an appropriate charge amount to the developer using the friction between the carrier and the developer by mixing the aforementioned carrier and the developer.

Since the yellow developer 100, which is a developer of a single component development system, is a negatively chargeable developer as described above, a negative charge amount is applied to the yellow developer 100. The saturated charge amount of the yellow developer 100 as a negative developer is not especially limited, but is, for example, −50 μC/g to −10 μC/g.

[Configuration of Yellow Developer]

The yellow developer 100 is, for example, a plurality of particles. Each of the plurality of particulate developers 100 includes, as shown in FIG. 3, external additives 102.

More specifically, the yellow developer 100 includes a mother particle 101 and yellow external additives 102 (first external additives) fused to the mother particle 101, and the yellow external additives 102 are a plurality of particles. That is, the plurality of particulate developers 100 include a plurality of mother particles 101 and a plurality of particulate external additives 102 fused to each of the mother particles 101.

The mother particle 101 includes, for example, a yellow coloring agent. However, the mother particle 101 may include any one type or two or more types of other materials along with the yellow coloring agent.

Each of the mother particles function as a core of a piece of the developer. In the embodiment, the mother particles are illustrated as a single piece (or a mono structure) in FIG. 3. The mother particle, however, may be formed with multiple pieces. The external additives are fused to the mother particles such that some of the additives are attached on the surfaces of the mother particles and some of the additives are embedded in the mother particles.

The yellow coloring agent mainly colors an image, which is formed using the yellow developer 100, yellow (or making the image yellow). The yellow coloring agent includes any one type or two or more types of an arbitrary yellow color pigment, an arbitrary yellow color dye (pigment), etc. The yellow pigment is, for example, pigment yellow 74. The yellow color dye is, for example, C. I. pigment yellow and Cadmium yellow.

Further, the content rate of the yellow coloring agent in the yellow developer 100 is not especially limited, but is, for example, 2 parts by weight to 25 parts by weight to the content rate of the later described binding agent (100 parts by weight), and preferably 2 parts by weight to 15 parts by weight.

The type of the other materials is not especially limited, but is, for example, a binding agent, a release agent, and a charge control agent.

The binding agent mainly binds the yellow coloring agent, etc. The binding agent includes, for example, any one type or two or more types of polymer compounds, such as, e.g., a polyester based resin, a styrene-acrylic based resin, an epoxy based resin, and a styrene-butadiene based resin.

Among them, the binding agent preferably includes a polyester based resin. Since the polyester based resin has a high affinity to the medium M such as a paper, the yellow developer 100 including a polyester based resin as the binding agent can easily fuse to the medium M. Further, since the polyester based resin has a high physical strength even when the molecular weight is comparatively small, the developer including the polyester based resin as the binding agent has excellent durability.

The polyester based resin is, for example, a reactant (condensation polymer) of one or two or more alcohols and one or two or more carboxylic acids.

The type of alcohol is not especially limited, but among them, dihydric or higher alcohol or its derivative is preferable. The dihydric or higher alcohol is exemplified by, for example, ethylene glycol, diethylene glycol, triethylene glycol, polyethylene glycol, propylene glycol, butanediol, pentanediol, hexanediol, cyclohexane dimethanol, xylene glycol, dipropylene glycol, polypropylene glycol, bisphenol A, hydrogenated bisphenol A, bisphenol A ethylene oxide, bisphenol A propylene oxide, sorbitol, and glycerin.

The type of carboxylic acid is not especially limited, but among them, a bivalent or higher carboxylic acid or its derivative is preferable. The bivalent or higher carboxylic acid is exemplified by, for example, maleic acid, fumaric acid, phthalic acid, isophthalic acid, terephthalic acid, succinic acid, adipic acid, trimellitic acid, pyromellitic acid, cyclopentane dicarboxylic acid, succinic anhydride, trimellitic anhydride, maleic anhydride, and dodecenyl succinic anhydride acid.

The type the polyester based resin (crystal condition) is not especially limited. Therefore, the polyester based resin may be a crystalline polyester based resin, an amorphous polyester based resin, or both. Among them, it is preferable that the type of the polyester based resin be crystalline polyester. That is because the yellow developer 100 becomes more easily fusible by the medium M and the durability of the yellow developer 100 further improves.

To investigate whether or not the yellow developer 100 (mother particle 101) includes crystalline polyester as a binding agent, the yellow developer 100 may be, for example, analyzed using a differential scanning calorimetric measurement system (DSC). When a yellow developer 100 including crystalline polyester as a binding agent is analyzed using the differential scanning calorimetric measurement system twice continuously, an endothermic peak is detected within a range of 30° C. to 70° C. in the first measurement result, and an endothermic peak is not detected within the range of 30° C. to 70° C. in the second measurement result.

The release agent mainly improves the fusing property and the offset resistance of the yellow developer 100. The release agent includes one type or two or more types of waxes, such as, e.g., an aliphatic hydrocarbon based wax, oxides of an aliphatic hydrocarbon based wax, an aliphatic ester based wax, and a deoxidized aliphatic ester based wax. Further, the release agent may be, for example, a block copolymers of the aforementioned series of waxes.

The aliphatic hydrocarbon based wax is exemplified by, for example, low molecular weight polyethylene, low molecular weight polypropylene, olefin copolymer, a microcrystalline wax, a paraffin wax, and a Fischer-Tropsch wax. The oxide of the aliphatic hydrocarbon based wax is, for example, a polyethylene oxide wax, etc. The aliphatic ester based wax is, for example, a carnauba wax, a montan acid ester wax, etc. The deoxidized aliphatic ester based wax is a wax in which a part or all of the aliphatic ester based wax is deoxidized, and is, for example, a deoxidation carnauba wax.

Further, the content rate of the release agent in the yellow developer 100 is not especially limited, but is, for example, 0.1 parts by weight to 20 parts by weight to the content rate of the binding agent (100 parts by weight), preferably 0.5 parts by weight to 12 parts by weight.

The charge control agent mainly regulates the frictional chageability of the yellow developer 100, etc. The charge control agent used in the yellow developer 100 as a negatively chargeable developer includes, for example, any one type or two or more types of an azo based complex, a salicylate based complex, a calixarene based complex, etc.

Further, the content rate of the charge control agent in the yellow developer 100 is not especially limited, but is, for example, 0.05 parts by weight to 15 parts by weight to the content amount (100 parts by weight) of the binding agent, preferably 0.1 parts by weight to 10 parts by weight.

The yellow external additive 102 mainly improves the flowability of the yellow developer 100 by suppressing the agglomeration of the yellow developer 100 (mother particles 101) to each other. However, the yellow external additive 102 also functions to improve, for example, the environmental stability, the charging stability, the developability, the preservability, the cleanability, etc., of the yellow developer 100.

The yellow external additives 102 are, as described above, a plurality of particles and fused to the mother particle 101. Therefore, the plurality of particulate yellow external additives 102 exists on the surface of the mother particle 101 and its vicinity while being fixed to the mother particle 101.

To make it easy for the plurality of particulate yellow external additive 102 to exist on the surface of the mother particle 101 and its vicinity, the mean particle diameter of the plurality of particulate yellow external additives 102 is smaller than the mean particle diameter of the plurality of mother particles 101. However, the “mean particle diameter” described relating to the present invention is the so-called median size (D50: μm) and will be the same hereinafter.

The mean particle diameter of the plurality of particulate yellow external additive 102 is not especially limited as long as it is set to be smaller than the mean particle diameter of the plurality of mother particles 101. Therefore, the mean particle diameter of the plurality of particulate yellow external additives 102 may be arbitrarily set. In this case, two or more types of yellow external additives 102 having different mean particle diameters from each other may be used together.

The yellow external additive 102 includes, for example, any one type or two or more types of inorganic materials, organic materials, etc. The inorganic material is, for example, a hydrophobic silica, etc. The organic material is, for example, a melamine resin, etc.

In this yellow developer 100, for example, by improving the fusing property of the yellow external additive 102 to the mother particle 101, the yellow external additive 102 is suppressed from peeling (falling off) from the mother particle 101 at the time of forming an image. Along with this, it is preferable that a part or all of the plurality of particulate yellow external additives 102 be partially or entirely entered in the mother particle 101.

The aforementioned “partially or entirely entered in the mother particle 101” means that a part or all of the yellow external additive 102 is positioned inside the outline L (inside the mother particle 101) when focusing on the outline (outer edge) L of the mother particle 101.

Specifically, the plurality of particulate yellow external additive 102 includes, for example, yellow external additives 102A to 102C in three types of conditions. However, the yellow external additives 102 may include all of the yellow external additives 102A to 102C, or include only a part of the yellow external additives 102A to 102C. More specifically, the yellow external additives 102, for example, may include the yellow external additives 102A and only the yellow external additives 102B, may include the yellow external additive 102A and only the yellow external additive 102C, or may include the yellow external additive 102A and both the yellow external additives 102B and 102C.

The yellow external additive 102A exists on the surface of the mother particle 101, and the entirety of the yellow external additive 102A is positioned outside of the outline L of the mother particle 101. With this, since the yellow external additive 102A is not entered inside the mother particle 101, the yellow external additive 102A is more weakly held by the mother particle 101.

The yellow external additive 102B exists in the vicinity of the surface of the mother particle 101, and a part of the yellow external additive 102B is positioned inside of the outline L of the mother particle 101. With this, since a part of the yellow external additive 102B is entered inside the mother particle 101, the yellow external additive 102B is more strongly held by the mother particle 101.

The yellow external additive 102C exists in the vicinity of the surface of the mother particle 101, and the entirety of the yellow external additive 102C is positioned inside of the outline L of the mother particle 101. With this, since the entirety of the yellow external additive 102C is entered inside the mother particle 101, the yellow external additive 102C is significantly more strongly held by the mother particle 101.

As it is apparent from the comparison of the existential state of the yellow external additives 102A to 102C, since the fusing property of the mother particle 101 is higher in the order of 102A to 102C, the yellow external additives 102A to 102C are less likely to peel from the mother particle 101 in that order.

That is, since the yellow external additive 102A is more weakly held by the mother particle 101, the yellow external additive 102A has a tendency to peel from the mother particle 101 when repeating forming steps of images. Since the yellow external additive 102B is more strongly held by the mother particle 101, the yellow external additive 102B has a tendency to unlikely to peel from the mother particle 101 in comparison to the yellow external additive 102A even when repeating the image forming steps. Since the yellow external additive 102C is significantly strongly held by the mother particle 101, the yellow external additive 102C has a tendency to unlikely peel from the mother particle 101 in comparison to the yellow external additive 102B even when repeating the image forming steps.

Therefore, when the yellow external additive 102 includes one or both of the yellow external additives 102B and 102C, in comparison to the case in which the yellow external additive 102 does not include one or both of the yellow external additives 102B and 102C, the yellow external additive 102 is less likely to peel from the mother particle 101 at the time of image forming. In this way, the tendency in which the yellow external additive 102 is less likely to peel from the mother particle 101 becomes more significant as the ratio of each of the yellow external additives 102B and 102C in the yellow external additive 102 becomes larger.

To check whether a portion or the entirety of the plurality of particulate yellow external additives 102 is partially or entirely entered inside the mother particle 101, that is, to check whether the yellow external additive 102 includes one or both of the yellow external additives 102B and 102C, the yellow developer 100 may be observed, for example, using a microscope, such as a scanning electron microscope (SEM), etc.

The yellow developer 100 including the yellow external additive 102 (yellow external additives 102A to 102C) is, for example, as described later, is manufactured by performing a pre-external addition process and a post-external addition process in the manufacturing step of the yellow developer 100.

The shape of the yellow developer 100 is not especially limited, but it is preferably as close as possible to a sphere. That is because the transferability of the yellow developer 100 improves, thereby improving the quality of the image. Further, FIG. 3 shows a case in which the planar shape (outline) of the yellow developer 100 is circular.

More specifically, the average circularity degree of the plurality of particulate developers 100 is not especially limited, but among them, 0.955 to 0.970 is preferable. That is because the quality of the image improves sufficiently.

Further, the content rate of the yellow external additives 102 in the yellow developer 100 is not especially limited, but is, for example, 0.01 parts by weight to 10 parts by weight to the content rate of the binding agent (100 parts by weight), preferably 0.05 parts by weight to 8 parts by weight.

In such a case where the circularity degree and the particle diameter are high (or large), to adjust the fluidity of the yellow developer 100, as needed, an additional yellow external additive 102 having a comparatively large mean particle diameter (D50) may be used. The additional yellow external additive 102 includes, for example, one type or two or more types of the aforementioned inorganic particles, etc., and the mean particle diameter of the additional yellow external additive 102 is, for example, 50 nm or more. Further, the content rate of the release agent in the yellow external additive 102 in the yellow developer 100 is not especially limited, but is, for example, 0.5 parts by weight to 3 parts by weight to the content rate of the binding agent (100 parts by weight).

[Configuration of Developers of Other Colors]

The configuration of the magenta developer, the cyan developer, and the black developer, which are developers of other colors, can be, for example, similar to the configuration of the aforementioned yellow developer 100 except that the type of the coloring agent is different.

That is, the magenta developer includes a magenta external additive (second external additive) together with a magenta coloring agent (second coloring agent), and the magenta coloring agent mainly colors the image formed using the magenta developer magenta. The magenta coloring agent includes any one type or two or more types of a magenta pigment and a magenta dye (pigment). The magenta pigment is, for example, quinacridone, etc. The magenta pigment is, for example, C.I. pigment red 238, etc.

As a matter of course, the magenta developer may further include any one type or two or more types of other materials such as a binding agent, a release agent, a charge control agent, an external additive, etc. The content rate of the magenta coloring agent, etc., in the magenta developer is, for example, similar to the content rate of the yellow coloring agent, etc., in the yellow developer.

That is, the cyan developer includes a cyan external additive (second external additive) together with a cyan coloring agent (second coloring agent), and the cyan coloring agent mainly colors the image formed using the cyan developer cyan. The cyan coloring agent includes any one type or two or more types of the cyan pigment and the cyan dye (pigment). The cyan pigment is, for example, phthalocyanine blue (C.I. Pigment Blue 15:3), etc. The cyan dye is, for example, pigment blue 15:3, etc.

As a matter of course, the cyan developer may further include any one type or two or more types of other materials such as a binding agent, a release agent, a charge control agent, an external additive, etc. The content rate of the cyan coloring agent, etc., in the cyan developer is, for example, similar to the content rate of the yellow coloring agent, etc., in the yellow developer.

The black developer includes a black external additive (second external additive) together with a black coloring agent (second coloring agent), and the black coloring agent mainly colors the image formed using the black developer black. The black coloring agent includes any one type or two or more types of the black pigment and the black dye (pigment). The black pigment is, for example, carbon, etc. The black pigment is, for example, carbon black, etc., and the carbon black is, for example, furnace black, channel black, etc.

As a matter of course, the black developer may further include any one type or two or more types of the other materials such as a binding agent, a release agent, a charge control agent, an external additive, etc. The content rate of the black coloring agent, etc., in the black developer is, for example, similar to the content rate of the yellow coloring agent, etc., in the yellow developer.

Further, the magenta developer, similarly to the aforementioned yellow developer 100, may be manufactured by performing a pre-external addition process and a post-external addition process, and also may be manufactured by only performing a post-external addition process without performing a pre-external addition process. When a pre-external addition process is performed, it becomes easy for a part or all of the plurality of particulate magenta external additives to be partially or entirely entered in the mother particle. On the other hand, when a pre-external addition process is not performed, it becomes difficult for a part or all of the plurality of particulate magenta external additives to be partially or entirely entered in the mother particle.

The above description relating to the manufacturing method of the magenta developer is similarly applicable to the manufacturing method of each of each of the cyan developer and the black developer. That is, the cyan developer may be manufactured by performing a pre-external addition process and a post-external addition process, and also may be manufactured by performing only a post-external addition process without performing a pre-external addition process. The black developer may be manufactured by performing a pre-external addition process and a post-external addition process, and also may be manufactured by performing only a post-external addition process without performing a pre-external addition process.

[Physical Properties of Developer]

Between the yellow developer 100 and the developers of other colors (magenta developer, cyan developer, and black developer), the magnitude correlation of the external additive to the mother particle in a fused state is optimized to suppress the occurrences of poor image quality caused by blade filming.

Specifically, the first peeling rate (%) calculated by the following formula (1) when applying ultrasonic waves to a polyoxyethylene lauryl ether solution (PLE) in which the yellow developer 100 is dispersed is defined.

First Peeling rate (%)=[1−(X1/Y1)]×100 (1)

(X1 is an amount (weight %) of the yellow external additive 102 included in the yellow developer 100 after ultrasonic waves are applied. Y1 is an amount (weight %) of the yellow external additive 102 included in the yellow developer 100 before ultrasonic waves are applied) However, the PLE solution is, as described above, a solution including PLE, which is an ether-type nonionic surfactant, and specifically, EMULGEN 109P (product name) manufactured by Kao Corporation. The conditions relating to the PLE solution are set such that density=5% and temperature=32° C. The conditions relating the application of ultrasonic waves are set such that the strength (wavelength)=40 kHz and the time=10 minutes.

Further, to disperse the yellow developer 100 in the PLE solution, 5 parts by weight of yellow developer 100 is added to 100 parts by weight of a PLE solution. In addition, after adding the yellow developer 100 to the PLE solution, the PLE solution is stirred for three hours or more.

The “first peeling rate” is an index showing the amount of the yellow external additive 102 that has peeled from the mother particle 101 caused by the application of ultrasonic waves, as it is apparent from the aforementioned formula (1). That is, a small first peeling rate means that the amount of the yellow external additives 102 that have peeled from the mother particle 101 caused by the application of ultrasonic waves is small. On the other hand, a large first peeling rate means that the amount of the yellow external additives 102 that have peeled from the mother particle 101 caused by the application of ultrasonic waves is large. However, the value of the first peeling rate calculated using the formula (1) is a value rounded off to the second decimal place.

Further, the second peeling rate (%) calculated by the following formula (2) when applying ultrasonic waves to a PLE solution in which each of the developers of other colors are dispersed is defined. The conditions such as the type of the PLE solution, the dispersion procedure, the stirring time, etc., are similar to those in the case in which the first peeling rate was defined.

Second peeling rate (%)=[1−(X2/Y2)]×100 (2)

(X2 is each amount (weight %) of the magenta external additive, the cyan external additive, and the black external additive included in the magenta developer, the cyan developer, and the black developer, respectively, after ultrasonic waves are applied. Y2 is each amount (weight %) of the magenta external additive, the cyan external additive, and the black external additive included in the magenta developer, the cyan developer, and the black developer, respectively, before ultrasonic waves are applied)

Here, for example, since three types of developers (magenta developer, cyan developer, and black developer) are used as developers of other colors, the second peeling rate is defined for each of the three types of developers. That is, the detail of the “second peeling rate” is similar to the detail of the aforementioned “first peeling rate”. That is, the value of the second peeling rate calculated using the formula (2) is a value rounded off the second decimal place.

In this case, the first peeling rate is set to be less than the second peeling rate. That is, the first peeling rate on the yellow developer 100 is less than the second peeling rate on the magenta developer. Further, the first peeling rate on the yellow developer 100 is less than the second peeling rate on the cyan developer. Furthermore, the first peeling rate on the yellow developer 100 is less than the second peeling rate on the black developer.

The reason why the first peeling rate is set to be less than the second peeling rate is to, as described above, suppress the occurrences of poor image quality caused by blade filming.

In detail, generally, the hardness of the material used as a yellow coloring agent tends to have a higher hardness than the material used as a coloring agent of a color other than yellow. The tendency becomes significant particularly when using a pigment. In this case, because the hardness of the yellow coloring agent is relatively high, it becomes easy for the yellow external additive 102 to peel from the yellow developer 100 (mother particle 101). When the yellow external additive 102 peels, when the yellow developer 100 is frictionally charged between the development roller 33 and the development blade 35, the yellow external additive 102 is unintentionally melted from the effects of heat and excessive pressure. With this, because the yellow external additive 102 adhered after melting forms an aggregate, a foreign substance (aggregate) is retained between the development roller 33 and the development blade 35, a phenomenon in which it becomes difficult for images to be formed normally due to the presence of the foreign substance, that is, blade filming, is likely to occur. The occurrences of blade filming naturally become a key factor of deteriorating the image quality. Specifically, when blade filming occurs, since poor adherence of the yellow developer 100 to the electrostatic latent image occurs, unintentional white lines (streaky missing image) may occur in the image along the rotational direction of the photosensitive drum 31.

However, when the first peeling rate is less than the second peeling rate, in the yellow developer 100, since the yellow external additive 102 is strongly fused to the mother particle 101, the yellow external additive 102 becomes less likely to peel from the mother particle 101. With this, since blade filming becomes less likely to occur even when a yellow developer 100 including a yellow coloring agent having a high degree of hardness is used, the quality of images is secured.

In this case, it is necessary to set the first peeling rate to be less than the second peeling rate, but the reason why the first peeling rate can be set to be relatively less than the second peeling rate is mainly because of the presence of the aforementioned yellow external additives 102B and 102C. That is, since the yellow external additives 102B and 102C held by the mother particle 101 are unlikely to peel from the mother particle 101 even when ultrasonic waves are applied to the yellow developer 100, the amount in which the yellow external additives 102B and 102C peel from the mother particle 101 is suppressed to be sufficiently small. Therefore, it is preferable that the yellow developer 100 which requires the first peeling rate to be set as small as possible be manufactured by performing a pre-external addition process and a post-external addition process so that the yellow external additive 102 includes, as described above, the yellow external additives 102A to 102C.

On the other hand, for the magenta developer which requires that the second peeling rate is set to be relative larger than the first peeling rate, when the second peeling rate can be set to be larger than the first peeling rate, it may be manufactured by performing a pre-external addition process and a post-external addition process, and also it may be manufactured by only performing the post-external addition process without performing the pre-external addition process. The description of the manufacturing method of the magenta developer herein can be similarly applied to the manufacturing method of each of the cyan developer and the black developer.

The first peeling rate is, as described above, not especially limited as long as it is set to be less than the second peeling rate. Among them, it is preferable that the first peeling rate be 20.5% or less. Since the first peeling rate becomes sufficiently less than the second peeling rate, blade filming becomes sufficiently less likely to occur.

[Manufacturing Method of Developer]

The yellow developer 100 is manufactured, for example, by the following processes.

The manufacturing method of the yellow developer 100 is not especially limited. That is, the yellow developer 100 may be, for example, manufactured by using a pulverization method, manufactured by using a polymerization method, or manufactured by other methods. Of course, two or more types of the aforementioned manufacturing methods may be used in combination to manufacture the yellow developer 100. The polymerization method is, for example, a dissolution suspension method, etc.

Here, for example, a case in which the yellow developer 100 is manufactured using a pulverization method will be described.

When manufacturing the yellow developer 100, initially, a mixture is obtained by mixing a yellow coloring agent and other materials, such as a binding agent, as necessary.

Next, after kneading the mixture while melting, the mixture after the melt-kneading is cooled to thereby obtain a precursor. In that case, as a device for melt-kneading, for example, any one type or two or more types of an extruder, a biaxial kneading device, etc., is used. The precursor is an ingot of the mother particle 101 including the aforementioned yellow coloring agent, etc.

Next, by classifying the pulverized precursor after pulverizing the precursor, a plurality of mother particles 101 is obtained. The number of the pulverization process may by one, or two or more. When the number of the pulverization process is two or more, one or more coarse grinding processes and one or more fine grinding processes may be performed. In this case, as a pulverization device, for example, any one type or two or more types among a cutter mill, a jet mill, a collision pulverization device, etc., is used. As a device for classification, for example, any one type or two or more types of an air-classifier, etc., is used.

Particularly, when pulverizing a precursor, by adding a yellow external additive 102 to the precursor to perform the pre-external addition process, the precursor is pulverized in a state in which the precursor coexists with the yellow external additive 102. The addition amount of the yellow external additive 102 is set to a part of an amount W1 of the total amount W of the yellow external additive 102 to be ultimately included (after the completion of the manufacturing of the yellow developer 100) in the yellow developer 100 (W1<W). In the pre-external addition process, since the yellow external additive 102 is added to the precursor while the precursor is being pulverized, the yellow external additive 102 is fused to the mother particle 101 and a part of the yellow external additive 102 (yellow external additives 102B and 102C) enters inside the mother particle 101. Therefore, in the pre-external addition process, mainly the yellow external additives 102B and 102C among the aforementioned yellow external additives 102A to 102C become likely to be formed.

Finally, to perform a post-external addition process, after the yellow external additives 102 are added to the mother particle 101, the mother particle 101 is stirred in a state in which it coexists with the yellow external additives 102. The addition amount of the yellow external additives 102 is the remaining amount W2 of the total amount W of the yellow external additives 102 to be ultimately included in the yellow developer 100 (=W−W1). In this case, as a post-external addition device, for example, any one type or two or more types of a Henschel mixer, etc., is used. In the post-external addition process, the yellow external additives 102 are fused to the mother particle 101. Therefore, in the post-external addition process, mainly the yellow external additive 102A among the aforementioned yellow external additives 102A to 102C becomes likely to be formed.

With this, the yellow developer 100 is obtained. When manufacturing this yellow developer 100, for example, the aforementioned peeling rate may be controlled by adjusting the addition amount W1 of the yellow external additive 102 in the pre-external addition process.

Further, the manufacturing method of the magenta developer is not especially limited. That is, the magenta developer may be manufactured by, similarly to the manufacturing method of the aforementioned yellow developer 100, performing a pre-external addition process and a post-external addition process, and also may be manufactured by performing only a post-external addition process without performing a pre-external addition process. The description herein relating to the manufacturing method of the magenta developer is similarly applicable to the manufacturing method of the cyan developer and the black developer.

<1-4. Operation>

Next, the operation of the image forming apparatus will be described.

Here, with reference to FIG. 1 and FIG. 2, a case in which an image is formed on one side of the medium M will be described. In this case, the medium M accommodated in the tray 11 is used.

The image forming apparatus, as described hereinafter, for example, performs a development process, a transfer process, a fusing process, and a cleaning process.

[Development Process]

The medium M accommodated in the tray 11 is taken out by the send out roller 21. The medium M is carried by the carrying rollers 61 to 62 along the carrying path R1 in the direction of the arrow F1.

In the development process, in the development part 30Y, when the photosensitive drum 31 rotates, the charge roller 32 applies a direct current voltage on the surface of the photosensitive drum 31 while rotating. With this, the surface of the photosensitive drum 31 is evenly charged.

Next, according to an image signal, an LED head 37 irradiates light on the surface of the photosensitive drum 31. With this, since the surface potential attenuates (light attenuation) at the light irradiation portion on the surface of the photosensitive drum 31, an electrostatic latent image is formed on the surface of the photosensitive drum 31.

On the other hand, in the development part 30Y, a yellow developer accommodated in the cartridge 38 is released toward the supply roller 34.

After a voltage is applied to the supply roller 34, the supply roller 34 rotates. With this, a yellow developer is supplied to the surface of the supply roller 34 from the cartridge 38.

After a voltage is applied to the development roller 33, the development roller 33 rotates while being contacted and pressed by the supply roller 34. With this, since a yellow developer supplied to the surface of the supply roller 34 is absorbed on the surface of the development roller 33, the developer is carried by using the rotation of the development roller 33. In this case, since a part of the yellow developer absorbed on the surface of the development roller 33 is removed by the development blade 35, the thickness of the yellow developer absorbed on the surface of the development roller 33 is made even.

After the photosensitive drum 31 rotates while being contacted and pressed by the development roller 33, the yellow developer absorbed on the surface of the development roller 33 is transferred to the surface of the photosensitive drum 31. With this, since the yellow developer adheres to the surface of the photosensitive drum 31 (electrostatic latent image), a yellow developer image is formed.

[Primary Transfer Process]

In the transfer part 40, when the drive roller 42 rotates, the driven roller 43 and the backup roller 44 rotate in accordance with the rotation of the drive roller 42. With this, the intermediate transfer belt 41 moves in the direction of the arrow F5.

In the primary transfer process, a voltage is applied to the primary transfer roller 45Y. Since the primary transfer roller 45Y is contacted and pressed to the photosensitive drum 31 via the intermediate transfer belt 41, the yellow developer adhered to the surface of the photosensitive drum 31 (electrostatic latent image) in the development process is transferred to the intermediate transfer belt 41.

After this, the intermediate transfer belt 41 in which the yellow developer is transferred continues to move in the direction of the arrow F5. With this, in the development parts 30M, 30C, and 30K and the primary transfer rollers 45M, 45C, and 45K, the development process and the primary transfer process are performed in the same order by the same procedures as the aforementioned development part 30Y and the primary transfer roller 45Y. Therefore, since the developer of each color (magenta, cyan, and black) is sequentially transferred to the intermediate transfer belt 41, the developer image of each color is formed.

That is, since the magenta developer is transferred onto the surface of the intermediate transfer belt 41 by the development part 30M and the primary transfer roller 45M, a magenta developer image is formed. Next, since the cyan developer is transferred onto the surface of the intermediate transfer belt 41 by the development part 30C and the primary transfer roller 45C, a cyan developer image is formed. Next, since the black developer is transferred onto the surface of the intermediate transfer belt 41 by the development part 30K and the primary transfer roller 45K, a black developer image is formed.

Of course, whether or not the development process and the transfer process are actually performed in each of the development parts 30Y, 30M, 30C, and 30K and the primary transfer rollers 45Y, 45M, 45C, and 45K will be determined according to the color required to form an image (the type and the combinations of the developers).

[Secondary Transfer Process]

The medium M carried along the carrying path R1 passes between the backup roller 44 and the secondary transfer roller 46.

In the secondary transfer process, a voltage is applied to the secondary transfer roller 46. Since the secondary transfer roller 46 is contacted and pressed to the backup roller 44 via the medium M, the developer transferred to the intermediate transfer belt 41 in the aforementioned primary transfer process is transferred to the medium M.

[Fusing Process]

After the developer is transferred to the medium M in the secondary transfer process, the medium M is put into the fuser 50 since it is continuously carried in the direction of the arrow F1 along the carrying path R1.

In the fusing process, the surface temperature of the heat application roller 51 is controlled to be a predetermined temperature. When the pressure application roller 52 rotates while being contacted and pressed to the heat application roller 51, the medium M is carried so as to pass between the heat application roller 51 and the pressure application roller 52.

With this, since the developer transferred on the surface of the medium M is heated, the developer melts. Furthermore, since the developer in the melted condition is contacted and pressed to the medium M, the developer strongly adheres to the medium M. Therefore, an image is formed on the surface of the medium M.

Since the medium M in which an image is formed is carried by the carrying roller 63 along the carrying path R2 in the direction of the arrow F2, it is sent out to the stacker part 2.

Further, although it is not described in detail here, the carrying procedure of the medium M is changed according to the pattern of the image to be formed on the surface of the medium M.

For example, when an image is formed on both sides of the medium M, the medium M that passed the fuser 50 is carried in the directions of the arrows F3 and F4 along the carrying paths R3 to R5 by the carrying rollers 64 to 67, and then again carried in the direction of the arrow F1 by the carrying rollers 61 and 62 along the carrying path R1. In this case, the direction in which the medium M is carried is controlled by the carrying path switching guides 71 and 72. With this, on the back side of the medium M (surface in which an image is not yet formed), the development process, the primary transfer process, the secondary transfer process, and the fusing process are performed again.

In addition, for example, when an image is formed on one side of the medium M multiple times, the medium M that passed the fuser 50 is carried in the direction of the arrows F3 and F4 by the carrying rollers 64 to 66 along the carrying paths R3 and R5, and then again carried in the direction of the arrow F1 by the carrying rollers 61 and 62 along the carrying path R1. In this case, the direction in which the medium M is carried is controlled by the carrying path switching guide 71 and 72. With this, on the surface of the medium M (surface in which an image is already formed), the development process, the primary transfer process, the secondary transfer process, and the fusing process are performed again.

[Cleaning Process]

In this image forming apparatus, a cleaning process is performed at an arbitrary timing.

In the development part 30Y, there are cases in which unnecessary developers remain on the surface of the photosensitive drum 31. The unnecessary developers are, for example, a part of the developer used in the primary transfer process, and a developer that was not transferred onto the intermediate transfer belt 41 and remained on the surface of the photosensitive drum 31.

Therefore, in the development part 30Y, since the photosensitive drum 31 rotates in a state in which it is contacted and pressed to the cleaning blade 36, the developer remaining on the surface of the photosensitive drum 31 is scraped off by the cleaning blade 36. With this, the unnecessary developer is removed from the surface of the photosensitive drum 31.

Further, the cleaning process using the aforementioned cleaning blade 36 is performed similarly in the development parts 30G, 30C, and 30K.

Furthermore, in the transfer part 40, there are cases in which a portion of the developer that was transferred to the surface of the intermediate transfer belt 41 in the primary transfer process is not transferred onto the surface of the medium M in the secondary transfer process and remains on the surface of the intermediate transfer belt 41.

Therefore, in the transfer part 40, when the intermediate transfer belt 41 moves in the direction of the arrow F5, the developer remaining on the surface of the intermediate transfer belt 41 is scraped off by the cleaning blade 47. With this, the unnecessary developer is removed from the surface of the intermediate transfer belt 41.

<1-5. Functions and Effects>

In the image forming apparatus, the first peeling rate on the yellow developer 100 is set to be less than the second peeling rate on the developer of other colors (magenta developer, cyan developer, and black developer). In this case, as described above, even in a case in which the yellow developer 100 includes a yellow developer 100 with a high degree of hardness, blade filming is less likely to occur since the yellow external additive 102 is less likely to peel from the yellow developer 100 (mother particle 101). Therefore, since the quality deterioration of the image due to blade filming is suppressed, a high quality image can be obtained.

In particular, when the first peeling rate is 20.5% or less, since the first peeling rate is sufficiently less than the second peeling rate, blade filming is less likely to occur. Therefore, better effects can be obtained.

Further, in the yellow developer 100, when a part or all of the plurality of particulate yellow external additive 102 has partially or entirely entered in the mother particle 101, the yellow external additive 102 is strongly fused to the mother particle 101. Therefore, the first peeling rate can be easily and stably set so as to be less than the second peeling rate.

Further, when the average circularity degree of the plurality of particulate yellow developer 100 is 0.955 to 0.970, even better effects can be obtained since the transferability, etc., of the yellow developer 100 improves.

In the application, the circularity degrees of the developer was measured under the following conditions.

The measuring instrument was FPIA-3000S (manufactured by SYSMEX Corporation). As a preparation for the measurement, 150 mg of toner was placed in a beaker, and a dispersing agent solution was added thereto to make the solution a volume of 15 ml. Thereafter, dispersion treatment was performed while applying ultrasonic waves (100 W) for 2 minutes.

The lens magnification was 20 times, the measurement mode was HPF, the imaging magnification was 40 times, the appropriate measurement range was 0.8 to 20 and the particle sheath (aqueous system) was used as the sheath liquid. The measurement was performed with a valid analyzing number of 1000 pieces.

The method of measuring the circularity degrees is not necessary limited to the above. Other known methods are available to determine the circularity or another feature of the particles.

Furthermore, when the yellow developer 100 includes a crystalline polyester as a binding agent, the yellow developer 100 is more easily fused to the medium M and since the durability of the yellow developer 100 further improves, even better effects can be obtained.

Here, the significance of obtaining the aforementioned functions and effects are as described hereinafter in detail.

To realize the energy reduction of the image forming apparatus, the developer needs to be melted at the lowest possible temperature in the step to fuse the developer to a medium. Therefore, when the melting point of the developer is lowered, the external additive is fused to the mother particle to thermally protect the mother particle using the external additive so that the developer does not melt at a place other than the fusing part. In this case, as the coverage of the mother particle by the external additive is increased, the mother particle can be suppressed from unintentionally melting.

However, when the forming step of the image is repeated by repeatedly using the image forming apparatus for a long period of time, the external additive is more likely to peel from the mother particle. This tendency becomes more significant as the usage period (number of image formation) of the image forming apparatus increases. When the external additive peels too much from the mother particle, it becomes the cause of poor image quality since the developer is likely to unintentionally melt at a place other than the fusing part.

In particular, when a single component development system developer including a yellow coloring agent with a high degree of hardness is used as the yellow developer, as described above, the yellow developer is likely to melt when it is frictionally charged between the development roller and the development blade, so blade filming is likely to occur. With this, since it becomes difficult to normally form images due to the occurrences of blade filming, the quality of the images deteriorates.

From the aforementioned reasons, when using a yellow developer including external additives, since the improvement of the lowering of the melting point of the yellow developer and the suppression of occurrence of blade filming have a trade-off relationship, it is difficult to achieve both the energy reduction of the image forming apparatus and the quality assurance of images. That is, when the melting point of the yellow developer is lowered, the energy of the image forming apparatus can be reduced, but on the other hand, since blade filming becomes likely to occur, it becomes difficult to obtain high quality images. On the other hand, when the melting point of the yellow developer is raised, blade filming becomes less likely to occur and high quality images can be obtained, but on the other hand, since the image forming apparatus requires high energy, it becomes difficult to achieve energy reduction for the image forming apparatus.

On the other hand, in the image forming apparatus of the present invention, as described above, since the first peeling rate of the external additive on the yellow developer is set to be less than the second peeling rate on each of the magenta developer, the cyan developer, and the black developer, the occurrence of blade filming can be suppressed while lowering the melting point of the yellow developer. Therefore, since the aforementioned trade-off relationship can be broken, a high quality image can be obtained while realizing energy reduction for the image forming apparatus.

### 2. Modified Example

In FIG. 1, four development parts 30 (30Y, 30M, 30C, and 30K) corresponding to the four types of colors (yellow, magenta, cyan, and black) are used, but the number of the development parts 30 is not especially limited. The number of the development part 30 can be arbitrarily set according to the conditions, such as the number of colors used when forming an image.

Specifically, the type of the developer of other colors to be used with the yellow developer 100 is not limited to the aforementioned three types (magenta developer, cyan developer, and black developer), and may be two types or four or more types according to the image to be ultimately formed. Also in this case, similar effects can be obtained by setting the first peeling rate to be less than the second peeling rate.

### EXAMPLES

The examples of the present invention will be described in detail. Further, the order of descriptions is as follows:

1. Manufacturing the developer

2. Physical properties of the developer

3. Evaluation of the image formed using the developer

<1. Manufacturing of Developer>

Five types of developers S1 to S5 were manufactured using a pulverization method according to the procedures described hereinafter. The developers S1 to S5 were used as four types of developers (yellow developer, magenta developer, cyan developer, and black developer) by changing the type of coloring agent.

Initially, a mixture was obtained by mixing a coloring agent, a binding agent (crystalline polyester), a release agent (polyolefin wax), and a charge control agent (salicylate base complex). The mixing ratio was set to 5 parts by weight of a coloring agent, 3 parts by weight of a release agent, and 0.3 parts by weight of a charge control agent to 100 parts by weight of a binding agent.

To manufacture the yellow developer, a yellow pigment (pigment yellow 74) was used as the yellow coloring agent. To manufacture the magenta developer, a magenta pigments (quinacridone) was used as the magenta coloring agent. To manufacture the cyan developer, a cyan pigment (phthalocyanine blue (C.I. Pigment Blue 15:3) was used as the cyan coloring agent. To manufacture the black developer, a black pigment (carbon black) was used as the black coloring agent.

Next, after melt-kneading the mixture using an extruder, a precursor was obtained by cooling the melt-kneaded mixture.

Next, the precursor was coarsely grinded using a cutter mill and after the precursor was continuously finely grinded using a jet mill, the precursor after fine grinding was classified using an air-classifier to obtain a mother particle. When coarsely or finely grinding the precursor, to perform a pre-external addition process, external additives were added to the precursor. As the external additives, a mixture of a hydrophobic silica (R972 manufactured by Japan Aerosil Corporation: mean particle diameter (D50)=16 nm) and melamine resin particles (EPOSTERs manufactured by Nippon Shokubai Co., Ltd., mean particle diameter (D50)=0.2 μm) was used. The addition amount of the external additive (pre-external addition amount: %) is as shown in Table 1. Further, as an example, a pre-external addition amount of “40%” means a weight corresponding to 40% of the total weight (100%) of the external additives ultimately included in the developer.

Finally, to perform a post-external addition process, after external additives were added to the mother particles, the mother particles and the external additives were mixed and stirred using a Henschel mixer. The type of the external additives added in the post-external addition process is the same as the type of external additives added in the pre-external addition process. The addition amount of the external additives (post-external addition amount: %) is as shown in Table 1. Further, as an example, a post-external addition amount of “60%” means a weight corresponding to 60% of the total weight (100%) of the external additives ultimately included in the developer.

Further, for the developers S1 to S3, the total addition amount of the external additives, that is, the sum total of the pre-external addition amount and the post-external addition amount, was set to be 100%. On the other hand, for the developers S4 and S5, for comparison, the total addition amount of the external additives was set to be more than 100%. Specifically, for the developer S4, the post-external addition amount was set to be twice as much compared to the developer S1. For the developer S5, the post-external addition amount was set to be 2.5 times as much compared to the developer S1. The total addition amount of the external additives was set so that there was 4 parts by weight hydrophobic silica and 0.3 parts by weight melamine resin particles to 100 parts by weight of the mother particles.

With this, the developers S1 to S5 were obtained. The developers S1 to S5 were negatively chargeable developers. Further, the average circularity degree of the developers S1 to S5 was 0.960.

<2. Physical Properties of Developer>

The peeling rate (%) of the developers S1 to S3 were examined using the procedure described hereinafter. Further, hereinafter, a case in which the physical properties of the developer S1 were examined will be exemplified and described. The procedures in which their physical properties of the developers S2 to S5 were examined were the same as the procedures to examine the physical properties of the developer S1.

Initially, using an energy dispersive X-ray fluorescence spectrometer (EDX-800HS manufactured by Shimadzu Corporation), the amount of the external additives contained (included) in the developer S1 (external additive amount before applying ultrasonic waves: weight %) was measured.

Next, after introducing 5 parts by weight of the developer S1 to 100 parts by weight of the PLE solution and stirring the PLE solution, the developer S1 was dispersed in the PLE solution. In this case, EMULGEN 109P manufactured by Kao Corporation was used as the PLE solution and the stirring time was set to three hours. The conditions relating to the PLE solution was set to: density=5% and temperature=32° C.

Next, ultrasonic waves were applied to the PLE solution in which the developer S1 was dispersed. To apply ultrasonic waves to the PLE solution, an ultrasonic cleaner (USCLEANER US-2R manufactured by AS one Corporation) was used. The application condition of ultrasonic waves was set to: strength=40 kHz, and time=10 minutes. After applying the ultrasonic waves, the PLE solution was filtered using pure water or a filter paper (thickness=100 mm) and then the residue (the developer S1 after applying the ultrasonic wave) was dried.

Next, with the same procedures in the aforementioned case in which the external additive amount before the application of the ultrasonic waves was examined, the amount of the external additives contained (included) in the residue (developer S1) (external additive amount after applying ultrasonic waves: weight %) was measured.

Finally, with respect to the yellow developer using developer S1, the first peeling rate (%) was calculated based on the aforementioned formula (1). When calculating the first peeling rate, the external additive amount (weight %) after applying the ultrasonic waves was set to X1 and the external additive amount (weight %) before applying the ultrasonic waves was set to Y1.

Further, for the magenta developer, the cyan developer, and the black developer using the developer S1, the second peeling rate (%) was calculated based on the aforementioned formula (2). When calculating the second peeling rate, the external additive amount (weight %) after applying the ultrasonic waves was set to X2 and the external additive amount (weight %) before applying the ultrasonic waves was set to Y2.

The peeling rates calculated for each of the developers S1 to S3 are shown in Table 1.

Further, since the developers S1 to S3 included a common binding agent (crystalline polyester), the common thermophysical properties were shown. Specifically, each of the glass-transition temperatures Tg of the developers S1 to S5 was all 60.8° C. Furthermore, when the developers S1 to S5 were continuously analyzed twice using a differential scanning calorimeter (EXSTAR600 manufactured by Seiko Instruments Inc.), a weak endothermic peak was detected in a range of 30° C. to 70° C. at the time of first melting, but an endothermic peak was not detected in a range of 30° C. to 70° C. at the time of second melting (at the time of melting again after cooling).

TABLE 1

| | | Post- | External Addition | | 1st Peeling |
|---|---|---|---|---|---|
| | Pre-External | External | Amount (wt %) | | Rate (%) |
| | Addition | Addition | Before | After | 2nd Peeling |
| Developer | Amount (%) | Amount (%) | App. | App. | Rate (%) |
| S1 | 40 | 60 | 3.6 | 2.3 | 36.1 |
| S2 | 70 | 30 | 3.9 | 2.9 | 25.6 |
| S3 | 90 | 10 | 3.9 | 3.1 | 20.5 |
| S4 | 40 | 120 | — | — | — |
| S5 | 40 | 150 | — | — | — |

<Evaluation of Image Formed Using Developer>

### Examples 1 to 12

Images were formed using each of the 12 types of developers as shown in Table 2 according to the procedures described below, and the images were evaluated. Since the types of the developers used herein were combinations of the three types of developers (developers S1 to S3) and the four types of colors (yellow (Y), magenta (M), cyan (C), and black (K), there was a total of 12 types.

In the following description, an example in which an image was evaluated using the developer S1 will be described. The procedures for evaluating the image using each of the developers S2 and S3 were the same as the procedures for evaluating the image using the developer S1.

After introducing a developer S1 into the cartridge of a development part, an image was formed using an image forming apparatus equipped with the development part. As an image forming apparatus, a color printer c711dn manufactured by Oki Data Corporation was used, and as a medium on which an image was formed, a color printer paper, Excellent White A4, made by Oki Data Corporation, was used. The type of the image was a solid image in each color (print duty=50%). That is, a yellow solid image, a magenta solid image, a cyan solid image, and a black solid image were formed. This image was an image in which horizontal band lines was printed by the number corresponding to 50% when the number of horizontal band lines to be printed in a normal solid image was 100%. The reason why the print condition (print duty value) was set to be large value (50%) was to deliberately make it easier for blade filming to occur by increasing the amount of the developer S1 passing between the development roller and the development blade.

The duty is defined as a proportion of an area to be printed with respect to the maximum printable area. When completely printing all of an printable area, the area ratio is determined as 100% duty (or 100% print duty). When only printing 1% area with respect to the printable area, the area ratio is determined as 1% duty (1% print duty).

When forming images, images were continuously formed for 6 days under the following environmental conditions. In this case, images were formed one by one in 10 seconds and the number of times of image formation per day was set to 5,000 times.

1^{st} day, 2^{nd} day: temperature=24° C., humidity=50%

3^{rd} day, 4^{th} day: temperature=28° C., humidity=80%

5^{th} day, 6^{th} day: temperature=10° C., humidity=20%

When forming images, due to, e.g., the friction between the development blade and the developer S1, the developer S1 was negatively charged. The negative charge amount of the developer S1 was −25 μC/g. In addition, each of the developers S2 to S5 was negatively charged, and the negative charge amount of each of the developers S2 to S5 was the same as the charge amount of the developer S1.

The occurrence of blade filming was evaluated while continuously forming images for 6 days, and the results shown in Table 2 were obtained.

In the case of checking the occurrence of blade filming, after the image forming operations (number of image forming=5,000 times) every day, the occurrence of stripes caused by the foreign substances on the surface of the development roller was visually checked. In this case, the case in which the stripes did not occur was judged as “A” and the case in which the stripes occurred was judged as “C”.

The reason why the surface of the development roller was checked for the occurrence of blade filming instead of the image quality of the image itself was that even when stripes occurred on the surface of the development roller, there are cases in which poor image quality can be difficult to check visually depending on the thickness of the stripes.

TABLE 2

| | | | 1st | 2nd | | | | | | |
|---|---|---|---|---|---|---|---|---|---|---|
| | | | Peeling | Peeling | Evaluation Result | | | | | |
| | | | Rate | Rate | 1 | 2 | 3 | 4 | 5 | 6 |
| Examples | Developer | Color | (%) | (%) | Day | Day | Day | Day | Day | Day |
| 1 | S1 | Y | 36.1 | — | A | C | C | C | C | C |
| 2 | S2 | Y | 25.6 | — | A | A | A | C | C | C |
| 3 | S3 | Y | 20.5 | — | A | A | A | A | A | A |
| 4 | S1 | M | — | 36.1 | A | A | A | A | A | A |
| 5 | S2 | M | — | 25.6 | A | A | A | A | A | A |
| 6 | S3 | M | — | 20.5 | A | A | A | A | A | A |
| 7 | S1 | C | — | 36.1 | A | A | A | A | A | A |
| 8 | S2 | C | — | 25.6 | A | A | A | A | A | A |
| 9 | S3 | C | — | 20.5 | A | A | A | A | A | A |
| 10 | S1 | K | — | 36.1 | A | A | A | A | A | A |
| 11 | S2 | K | — | 25.6 | A | A | A | A | A | A |
| 12 | S3 | K | — | 20.5 | A | A | A | A | A | A |

Environmental Conditions:
1st day, 2nd day: Temp. = 24 C. °, Humidity = 50%
3rd day 4th day: Temp. = 28 C. °, Humidity = 80%
5rd day 6th day: Temp. = 10 C. °, Humidity = 20%

The occurrence of blade filming varied greatly according to the type of the developer, that is, the color of the developer, the first peeling rate, and the second peeling rate.

Specifically, for each of magenta (M), cyan (C), and black (K) (examples 4 to 12), blade filming did not occur even in the case in which any of the developers S1 to S3 were used. That is, for magenta, cyan, and black, blade filming did not occur regardless of the second peeling rate.

On the other hand, for yellow (Y) (examples 1 to 3), blade filming occurred depending on the type of the developer S1 to S3, that is, the first peeling rate. However, as the first peeling rate becomes less, there was a tendency for blade filming to occur less.

Here, focus was put on the relationship between the first peeling rate on yellow, the second peeling rate on each of magenta, cyan and black, and occurrence of blade filming. In this case, when the first peeling rate is less than the second peeling rate, in comparison to when the first peeling rate is equal to the second peeling rate, blade filming was less likely to occur.

In particular, when the first peeling rate was less than the second peeling rate, when the first peeling rate was 25.6% or less, blade filming was less likely to occur, and when the first peeling rate was 20.5% or less, blade filming barely occurred.

### Examples 13 and 14

When occurrences of blade filming was checked using the same procedures as Examples 1 to 12 except that the developers S4 and S5 were used instead of developers S1 to S3, the results as shown in Table 3 were obtained. It should be noted that only the yellow developer was used here.

TABLE 3

| | | | Evaluation Result | | | | | |
|---|---|---|---|---|---|---|---|---|
| Examples | Developer | Color | 1 Day | 2 Day | 3 Day | 4 Day | 5 Day | 6 Day |
| 1 | S1 | Y | A | C | C | C | C | C |
| 13 | S4 | Y | A | A | A | A | C | C |
| 14 | S5 | Y | A | A | A | A | C | C |

Environmental Conditions:
1st day, 2nd day: Temp. = 24 C. °, Humidity = 50%
3rd day 4th day: Temp. = 28 C. °, Humidity = 80%
5rd day 6th day: Temp. = 10 C. °, Humidity = 20%

When the total amount of the external additive finally included in the developer is increased by increasing the post-external addition amount (Examples 13 and 14), compared to when the post-external addition amount was not increased (Example 1), blade filming was more likely to occur.

The results show that, to suppress the occurrence of blade filming, it is not effective to increase the total amount of the external additive, but it is effective to improve the fusing property of the external additive to the mother particles by performing a pre-external addition process.

Therefore, when using a yellow developer together with one, two or more developers of other colors, when the first peeling rate on to the yellow developer was less than the second peeling rate on to each of the one, two or more developers of other colors, the occurrence of blade filming was suppressed. Therefore, a high quality image was obtained.

Although the present invention has been described with reference to one embodiment, the present invention is not limited to the embodiment described in the above embodiment, and various modifications can be made. For example, the image forming system of the image forming apparatus according to an embodiment of the present invention is not limited to the intermediate transfer method using an intermediate transfer belt, but other image forming methods may be used.

With respect to the term, “circularity degree,” a mean value as well as the average value may be available as long as these values properly represent a feature of the particles. In the same fashion, with respect to the term, “particular diameter, an average value as well as the mean value may be available as long as the values properly represent a feature of the particles.

What is claimed is:

1. An image forming apparatus for developing an electrostatic latent image with developer, comprising:
a development part that attaches the developer to the electrostatic latent image;
a transfer part that transfers the developer attached to the electrostatic latent image to a medium; and
a fuser that fuses the developer on the medium, wherein
the developer includes:
first developer including a first coloring agent of yellow and a first external additive, and
second developer including a second coloring agent of a color other than yellow and a second external additive;
a first peeling rate of the first external additive calculated by a following formula (1) is smaller than a second peeling rate of the second external additive calculated by a following formula (2),
the first peeling rate (%)=[1−(X1/Y1)]×100 (1)
the second peeling rate (%)=[1−(X2/Y2)]×100 (2)
the first peeling rate is determined when ultrasonic waves are applied to a polyoxyethylene lauryl ether solution in which the first developer is dispersed,
X1 is an amount (weight %) of the first external additive included in the first developer after the ultrasonic waves are applied,
Y1 is an amount (weight %) of the first external additive included in the first developer before the ultrasonic waves are applied,
the polyoxyethylene lauryl ether solution is set such that a density=5% and a temperature=32° C., and
the application of the ultrasonic waves is set such that strength=40 kHz and time=10 minutes,
the second peeling rate is determined when ultrasonic waves are applied to the polyoxyethylene lauryl either solution in which the second developer is dispersed,
X2 is an amount (weight %) of the second external additive included in the second developer after the ultrasonic waves are applied,
Y2 is an amount (weight %) of the second external additive included in the second developer before the ultrasonic waves are applied,
the polyoxyethylene lauryl ether solution is set such that a density=5% and a temperature=32° C., and
the application of the ultrasonic waves is set such that strength=40 kHz and time=10 minutes.

2. The image forming apparatus according to claim 1, wherein
the second developer is composed with plural developers, each of which include a second coloring agent of a color other than yellow and a second external additive, and
one of the second coloring agents differs from others of the second coloring agents.

3. The image forming apparatus according to claim 1, wherein
the first peeling rate is 20.5% or less.

4. The image forming apparatus according to claim 1, wherein
the first developer is composed with a plurality of mother particles and the external additive, the mother particles containing the first coloring agent,
the first external additive is configured with a plurality of particles, the particles being fused to the mother particles, and
a mean particle diameter of the first external additive is smaller than a mean particle diameter of the mother particles.

5. The image forming apparatus according to claim 3, wherein
some of the particles of the first external additive are either partially or entirely embedded inside the mother particles.

6. The image forming apparatus according claim 1, wherein
the first developer is configured with a plurality of particles, and
an average circularity degree of the first developer is ranged within 0.955 to 0.970.

7. The image forming apparatus according to claim 1, wherein
the first developer further includes a binding agent in which a crystalline polyester is contained.

8. The image forming apparatus according to claim 6, wherein,
when the developer is analyzed twice continuously using a differential scanning calorimetry method,
there is an endothermic peak in a range within 30° C. to 70° C. in the first measurement result, and
there is no endothermic peak in a range within 30° C. to 70° C. in the second measurement result.

9. The image forming apparatus according to claim 1, wherein
the first developer is single component development system developer.

10. The image forming apparatus according to claim 1, wherein
the first developer is negatively chargeable developer.

11. The image forming apparatus according to claim 9, wherein
a saturated charge amount of the first developer is ranged within −50 μC/g to −10 μC/g.
